(19) United States
(12) Patent Application Publication
(10) Pub. No.: US 2024/0112849 A1
(43) Pub. Date: Apr. 4, 2024

(54) Transformer Coil

(71) Applicant: ABB Schweiz AG, Baden (CH)

(72) Inventors: Jedrzej Banaszczyk, Wieliczka (PL); Wojciech Piasecki, Kraków (PL); Michal Rzepecki, Kraków (PL); Filip Grecki, Aargau (CH); Uwe Drofenik, Zürich (CH)

(73) Assignee: ABB Schweiz AG, Baden (CH)

(21) Appl. No.: 18/475,559

(22) Filed: Sep. 27, 2023

(30) Foreign Application Priority Data
Sep. 30, 2022 (EP) 22199295.1

(51) Int. Cl. H01F 27/28; H01F 27/32

(52) U.S. Cl. CPC H01F 27/2823; H01F 27/288; H01F 27/325

(57) ABSTRACT

A transformer coil comprises low and high voltage windings wound on a supporting construction and immersed in a main insulation material. The transformer coil has also a first barrier arranged proximate the low voltage winding and a second barrier arranged proximate the high voltage winding. Each of the first and second barriers is gas-tight and semiconductive so that gas bubbles potentially released during immersion in the main insulation material are unable to migrate to a high electric field region during the casting process or during apparatus operation.

### CROSS-REFERENCE TO RELATED APPLICATIONS

The instant application claims priority to European Patent Application No. 22199295.1, filed Sep. 30, 2022, which is incorporated herein in its entirety by reference.

### FIELD OF THE DISCLOSURE

The present disclosure generally relates to a transformer coil and, more particularly, to a transformer coil for high power medium frequency transformer.

### BACKGROUND OF THE INVENTION

Medium frequency transformers have many applications in different technical fields, for example in power electronics or in electric rail transport. They are commonly used as power converters. In the state of the art there are known power transformers, where coil is wound with a standard wire. However, transformer coils of medium frequency transformers are wound using a Litz wire to minimize losses caused by high frequency phenomena, such as the skin effect. A Litz wire is made of multiple thin copper wires that are enameled and transposed with respect to each other, to form a single strand, in which the skin effect is effectively eliminated at medium frequencies. Alternatively medium frequency transformer coils/windings are also wound with aluminum or copper foil.

WO2022053995A1 discloses a construction of a primary coil and method of production of primary coil that can be used in a transformer. The elements included in the construction are primary winding with an interlayer insulation. The interlayer insulation and primary winding are impregnated with epoxy resin. Furthermore, the interlayer insulation material is an impregnable polyethylene terephthalate (PET) nonwoven fabric or crepe paper. The coil structure with the external grounded screen can be impregnated without voids with low viscosity impregnation resin, which eliminates the issue of partial discharges in medium voltage transformers.

WO2016176238A1 discloses a construction of electrical transformers that includes a barrier structure positioned between the high voltage winding and a low voltage winding or between the high voltage winding and a core, or between two higher voltage windings of a multi-phase electrical transformer. A barrier may be used within an electrical transformer to provide an insulative barrier for protecting against electrical failures. The barrier structure comprises a first material with a relatively lower permittivity value, such as a material having a permittivity value of about 2.5 or less and a second material with a relatively higher permittivity value. Thanks to the first material with lower permittivity value the barrier provides flashover resistance, while second material provides puncture resistance.

EP2833378A1 discloses a construction of a transformer, in particular medium frequency transformer. Said transformer has got windings formed from Litz wire and/or conductive foil. Between the primary winding and the secondary winding an insulating element is placed. Moreover, the construction of this transformer includes conducting shields which are placed on the insulating element without an air gap in between, thus protecting against partial discharges in the gap. The transformer has cooling channels, which might be filled with silicone gel, transformer oil, silicone-based or fluorinated hydrocarbons, polyurethane, synthetic rubber.

US2022037080A1 discloses a construction of a transformer that includes shielding arrangements which are placed between the primary and secondary windings. What is more, at least one of the windings may comprise a foil structure. The role of the shielding arrangements is to shield and/or redirect high strength electric fields away from areas of insulation material that may be prone to failure due to voids in insulation material. The electric shield may comprise a laminate structure that includes both metal and dielectric layers, and therefore might be also conductive.

During a production process of transformer coils for high voltage medium frequency transformers with windings made of Litz wire or conductive foil a supporting construction is required. Commonly, before casting process, the Litz wire windings are fixed into position by means of a glass-fiber structure and cotton strings. With such construction it is difficult to complete impregnate transformer coils with main insulation material like a silica-filled epoxy. The usage of Litz wires may cause air being trapped within the complex supporting structure or even within the Litz wire. Similarly, when windings in form of aluminium or copper foil are used, they have a simple supporting structure and have interlayers of insulation material. It is necessary to impregnate coils made of aluminium or copper foil with interlayers of insulation material. Even if vacuum casting is used, it is almost impossible for the silica-filled epoxy to penetrate the cotton strings or insulation material and to remove all residues of air. Besides air can be trapped between the layers of aluminium or copper foil or in the insulation material. Trapped air might migrate to other areas of the insulation system during the casting process and defects in the critical areas of the insulation system may appear. These issues are likely to trigger partial discharges during type tests, routine tests or during operation of transformer coils which might lead to damage of the apparatus. What is more, the use of cotton strings may lead to delamination on the surface of the Litz wires, which further may trigger partial discharges.

### BRIEF SUMMARY OF THE INVENTION

In one general aspect, the present disclosure describes a transformer coil comprising Litz wires or conductive foil that prevents gas migration to the high electric field regions which may lower the performance of a transformer due to the partial discharges. The disclosed embodiments include a transformer coil comprising a low voltage winding and high voltage winding which are wound on a supporting construction, and which are immersed in a main insulation material, and which has a first barrier arranged in the proximity of the low voltage winding and a second barrier arranged in the proximity of the high voltage winding. The essence of the invention is that the first and the second barrier is gas-tight and semiconductive. Semiconductivity is understand as covering surface-resistance in range between 400-1000Ω/□ (Ohm per square).

The most critical area from the insulation point of view is the region between the low voltage and high voltage windings. Shielding this region with a gas-tight semiconductive barrier eliminates the risk of partial discharges ignition caused by gas bubbles, for example released from the Litz wire during impregnation. Insulation of high electric field region is effectively shielded. The barriers are gas-tight, so that potentially released gas bubbles are not able to migrate to the high electric field regions during the casting process or during apparatus operation. Due to use of first and second barrier gas bubbles migration is not only limited, but also it is possible to achieve insulation system which is free of partial discharges, simplified construction of transformer, especially of the Litz wire winding supporting construction with reduced manpower and delivery time. What is more concentric positioning of the windings is simplified and scrap rate is also reduced.

It is also beneficial when the first and second barrier are made of semiconductive thermoplastic material or epoxy resin doped with carbon black, graphite, graphene nanotubes, silver, copper. These materials provide appropriate gas-tightness during production process of transformer coil, especially designated for the medium voltage frequency transformer. Gas-tightness is crucial during production process. In a transformer ready-to-use used materials provide temperature resistance which allows for continuous work at 150° C.

Preferably, transformer coil has individual casing for each winding and first and/or second barrier is incorporated into individual casing of each winding.

Low voltage and/or high voltage windings can be incorporated into gas-tight semiconductive casings. Therefore, casing can constitute a semiconductive barrier which have incorporated gas-tight barrier. In case only low or high voltage winding is incorporated into casing, the other one has assigned gas-tight and semiconductive barrier. During manufacturing process, the casings can be fixed directly to the mold walls facilitating production processes. It also enables to fill casings with a dielectric material, like a polyurethane (PUR), silicone gel, epoxy, or oil. The insulation material prevents short circuiting of the winding terminals to the semiconductive casings.

Beneficially, the supporting construction of the high voltage winding is made of semiconductive material, and the supporting construction of the low voltage winding is made of dielectric material.

The supporting construction of the high voltage winding made of semiconductive material shields the leads of the high voltage winding, whereas the supporting construction of the low voltage winding made of dielectric material provides electrical insulation between the low voltage winding and the transformer's coil. This way the LV winding and the coil can operate at different potentials.

### BRIEF DESCRIPTION OF THE SEVERAL VIEWS OF THE DRAWING(S)

FIG. 1 is a cross section through a transformer coil in accordance with a first embodiment of the present disclosure.

FIG. 2 is a cross section through a transformer coil in accordance with a second embodiment of the present disclosure.

FIG. 3 is a cross section through a transformer coil in accordance with a third embodiment of the present disclosure.

FIG. 4 is a cross section through a Litz wire in accordance with the disclosure.

FIG. 5 is a perspective view of a transformer coil in accordance with a fourth embodiment of the present disclosure.

FIG. 6 is a cross section through a transformer coil in accordance with a fourth embodiment of the present disclosure.

FIG. 7 is a cross section through a transformer coil in accordance with a fifth embodiment of the present disclosure.

FIG. 8 is a cross section through transformer coil Litz wires having a potentializing lead in accordance with the disclosure.

### DETAILED DESCRIPTION OF THE INVENTION

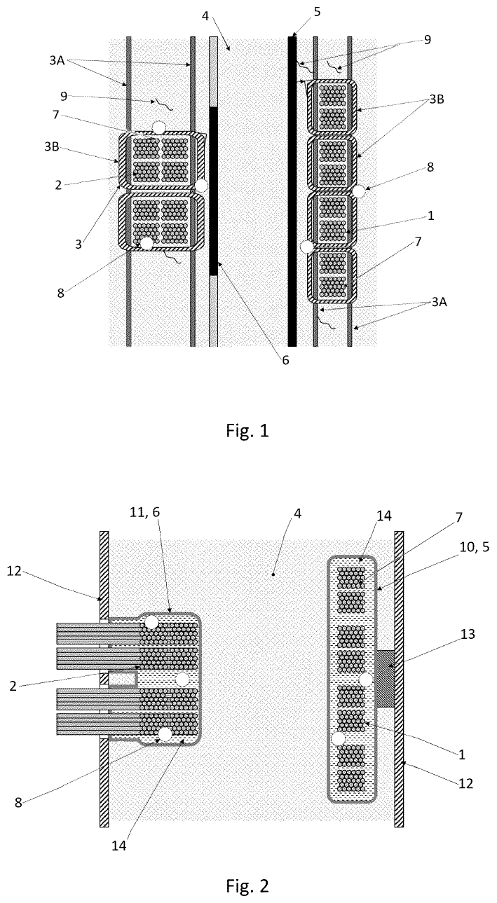

A high-power, medium frequency transformer coil (FIG. 1) comprises a low voltage winding 1 and a high voltage winding 2. Low voltage winding 1 and high voltage winding 2 are wound on a supporting construction 3 having glass fiber rods 3A and cotton fixing strings 3B. One function of the supporting construction 3 is holding or support of the transformer construction during assembly process. After assembly, the entire construction is immersed in insulation material 4 during a casting process. In this embodiment, a silica-filled epoxy is used as insulation material 4. In the proximity of the low voltage winding 1 there is a first barrier 5, and in in the proximity of the high voltage winding 2 there is a second barrier 6. Both barriers are gas-tight and semiconductive. Between them there is high electric filed region. In all herein described embodiments surface-resistance of barriers has a value of 600Ω/□ (Ohm per square) and is chosen from a range between 400-1000Ω/□ (Ohm per square).

Low voltage winding 1 and high voltage winding 2 are made of Litz wire 7. Litz wire 7 has been used to eliminate losses caused by the skin effect in medium frequency transformers. The Litz wire is made of multiple thin copper wires that are enameled and transposed with respect to each other, to form a single strand, in which the skin effect is effectively eliminated at medium frequencies. During casting and impregnating processes, silica-filled epoxy penetrates through the materials of the transformer. The impregnation process causes gas bubbles 8, which might be trapped near the low voltage winding 1 or high voltage windings 2. The critical area of high electric field regions is protected by the first barrier 5 and the second barrier 6. Barriers 5, 6 are gas-tight, so that potentially released gas bubbles 8 are not able to migrate to the high electric field regions during the casting process or during apparatus operation.

Barriers 5, 6 are made of semiconductive thermoplastic material doped with carbon black. In other embodiments, semiconductive thermoplastic material might be doped with graphite, graphene nanotubes, silver or copper. In further embodiments barriers can be made of epoxy resin doped with carbon black, graphite, graphene nanotubes, silver or copper. Gas-tight barriers 5, 6 may be made in the form of gas-tight tubes. The tubes can be made of a semiconductive thermoplastic material, they can be made of a dielectric material painted with semiconductive paint, or they can be 3D printed.

These materials provide appropriate gas-tightness during production process and temperature resistance during operation of the transformer coil which allows for continuous work at high temperatures, for example at 150° C.

In the second embodiment (FIG. 2), a transformer coil construction is similar to the first embodiment, however barriers 5, 6 have been incorporated into individual casings 10, 11 of low voltage winding 1 and high voltage winding 2. During assembly and production, individual casings 10, 11 are mounted to the mold walls 12 by the supporting construction. The supporting construction of the low voltage winding 1 has the form of dielectric support 13, while the supporting construction (not presented on the drawing) of the high voltage winding 2 is made of semiconductive material. Additionally, the casings 10, 11 are filled with dielectric material 14. In this embodiment, they are filed with silicone gel. Gas bubbles 8, which might appear are trapped inside casings 10, 11, and which have incorporated in their walls gas-tight and semiconductive barriers 5, 6. Barriers 5, 6 are made of semiconductive thermoplastic material doped with carbon black.

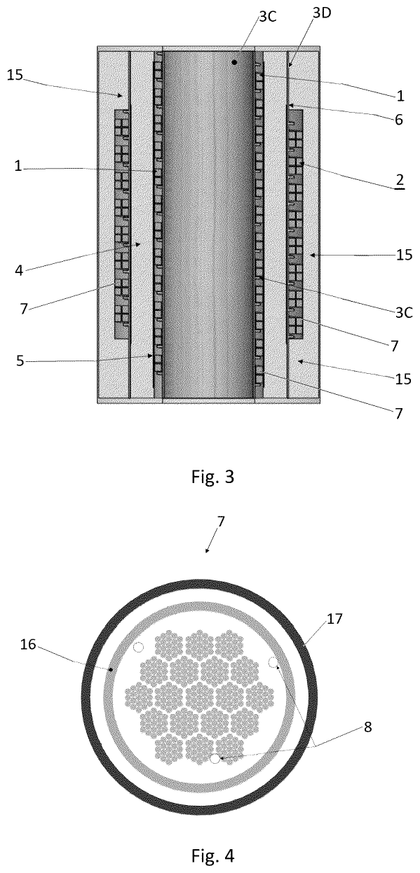

In the third embodiment (FIG. 3), a transformer coil construction is similar to the first embodiment, but the supporting construction 3 is formed of two bobbins 3C, 3D onto which the Litz wire 7 is wound. The external walls of bobbins 3C, 3D have supporting protrusions with through holes. The Litz wire is supported by these protrusions. Through holes in the protrusions facilitate epoxy flow and impregnation through the bobbin structure. Low voltage winding 1 is wound on the bobbin 3C placed inside the bobbin 3D with high voltage winding 2. Internal walls of bobbins 3C, 3D are lined up with interlayer insulation material 15, which is made of polyethylene terephthalate (PET) nonwoven fabric. What is more, interlayer insulation material 15, polyethylene terephthalate (PET) nonwoven fabric, is also used during assembly to resolve issues related to positioning and fixing of the Litz wires 7. Interlayer insulation material 15 that is subsequently soaked with insulation material 4, especially with epoxy resin, helps to achieve transformer insulation system which is void free and crack free, which eliminates the risk of partial discharges ignition. Interlayer insulation material 15 is also used in order to eliminate the empty spaces that appears on either side of the winding, and narrower polyethylene terephthalate (PET) nonwoven fabric is wound on the sides of the windings. Identically, as in previous embodiments, low voltage winding 1 and high voltage winding 2 have assigned gas-tight and semiconductive barriers 5, 6. On the outside of the of the low voltage winding 1 there is a first barrier 5. Whereas the second barrier 6 is placed on the inside part of the bobbin 3D with high voltage winding 2. Barriers 5, 6 are made of semiconductive, gas-tight thermoplastic material doped with carbon black.

In other embodiments, the bobbins used as a supporting construction can have a padding material on which the Litz wire is wound. Padding material holds Litz wire on its position on the bobbin. In such embodiments bobbins can be devoid of supporting protrusions.

Litz wire 7 (FIG. 4), which is used for windings, can have insulation shielding tubing, wherein an internal surface 16 of the tubing is made of dielectric material and forms insulation layer. An external surface 17 of the tubing is made of semiconductive material. With such tubbing it is possible to trap the gas bubbles 8 inside the Litz wire 7, so that the region between the low voltage and high voltage windings is not endangered by partial discharges caused by gas bubbles and is additionally protected.

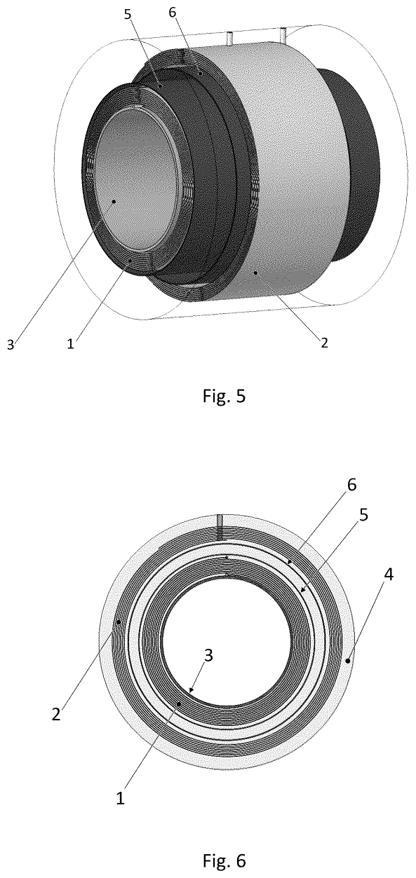

In a further embodiment, non-woven polypropylene (PP) has been used as an interlayer insulation material 15. Other characteristics of a transformer coil construction are the same as in third embodiment. Identically, as in the third embodiment, during production of the transformer coil non-woven polypropylene (PP), is subsequently soaked with insulation material 4, especially with epoxy resin. In the fourth embodiment (FIG. 5-6), a transformer coil has a low voltage winding 1 and a high voltage winding 2, which are made of copper sheet of foil with interlayers of insulation material in between the foil turns. Nonwoven fabric is used as interlayers of insulation material polyethylene terephthalate (PET). Copper foil has 0.1 mm thickness. Identically, as in previous embodiments, the entire transformer coil is impregnated with silica-filled epoxy, which is used as the main insulation 4. In a central part of the coil, there is a supporting construction 3. Also, as in previous embodiments, the low voltage winding 1 and the high voltage winding 2 have assigned gas-tight and semiconductive barriers 5, 6. Barriers 5, 6 are semiconductive and gas-tight, so that potentially released gas bubbles 8 are not able to migrate to the high electric field regions during the casting process or during apparatus operation. Barriers 5, 6 are made of semiconductive thermoplastic material doped with carbon black.

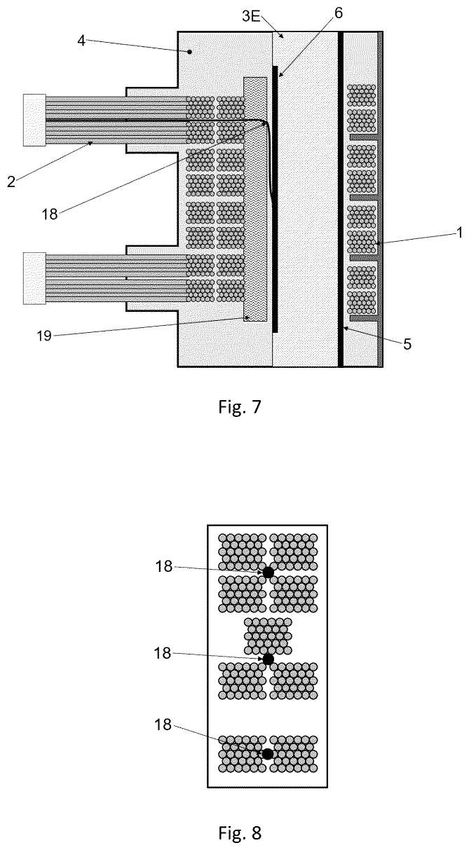

In the subsequent embodiment, in the high-power medium frequency transformer, in order to improve its efficiency, the high voltage barrier 6 (FIG. 7) is potentialized by a potentializing lead 18. In this embodiment, a transformer coil supporting construction 3 has the form of a bobbin 3C on which Litz wire 7 is wound. Low voltage winding 1 is wound on this bobbin 3C, which has supporting protrusions with through holes formed there. The Litz wire 7 is supported by these protrusions. Supporting construction 3 for high voltage winding 2 has the form of a bushing sleeve 3E. Bobbin 3C is placed inside this bushing sleeve 3E. Bushing sleeve 3E has, on its external wall, padding material 19. The Litz wire is wound on padding material 19. As in previous embodiments, the low voltage winding 1 and the high voltage winding 2 have assigned gas-tight and semiconductive barriers 5, 6. Barriers 5, 6 are semiconductive and gas-tight, so that potentially released gas bubbles 8 are not able to migrate to the high electric field regions during the casting process or during apparatus operation. Barriers 5, 6 are made of semiconductive thermoplastic material doped with carbon black.

The potentializing lead 18 is connected to the high voltage barrier 6 at an arbitrary position between the edge and the middle of the high voltage winding 2, where the potential difference between the high voltage winding 2 and the high voltage barrier is equal to 0-50% of the high voltage potential present on winding 2.

In this embodiment, the potentializing lead 18 is made of solid wire without additional insulation. The potentializing lead is positioned under the padding 19, which provides additional electric insulation between the high voltage winding 2 turns and the potentializing lead 18 at the site of the highest potential difference, i.e., in the middle of the high voltage winding 2. The potentializing lead is fed through the same bushing sleeve 3E as the high voltage winding 2. The special arrangement of the potentializing lead is that it is placed in-between individual Litz wire 7 bundles (FIG. 8). In this way the potentializing lead 18 is both screened electrically and protected mechanically.

However, in other embodiments, the potentializing lead 18 can be made out of stranded wire. Solid or stranded wire may or may not be enameled or fitted with additional insulation.

Preferably, at least one layer of an interlayer insulation material is interposed between layers of the windings, and the interlayer insulation material is made especially of polyethylene terephthalate (PET) nonwoven fabric or nonwoven polypropylene (PP).

In order to provide insulation, which is void free and crack free, and which eliminates the risk of partial discharge ignition, polyethylene terephthalate (PET) nonwoven fabric or nonwoven polypropylene (PP) is used as insulation material. Such a fabric, especially polyethylene terephthalate (PET) nonwoven fabric, is made by thermos-bond or spun-bond methods. It is preferred to use grammage between 10-200 g/m². The grammage depends on expected voltages and proper selection might resolve issues with supporting construction of windings. The Litz wire can be simply wound on the surface of the nonwoven PET fabric, and it can be used also as interlayer material between sheets of aluminum or copper foil. PET fabric can be also used to eliminate the empty space that appears on either side of the winding. What is more, narrower nonwoven PET fabric can be wound on the sides of the windings which completes insulation system of a transformer.

Preferably, the windings are made of a Litz wire. A Litz wire, in construction of transformer coil, minimizes losses caused by high frequency phenomena, such as the skin effect. Preferably, the Litz wire has insulation shielding tubing, wherein an internal surface of the tubing is made of dielectric material, and an external surface of the tubing is made of semiconductive material.

In case of Litz wire tubing, it is possible to trap the gas bubbles inside the Litz wire, so that the region between the low voltage and high voltage windings is not endangered by partial discharges caused by gas bubbles. When the internal surface of the tubing is dielectric, the ends of the winding do not get short-circuited. Usefully, the supporting construction for windings made of Litz wire is formed as at least one bobbin.

Alternatively, Litz wire can be wound on a supporting construction in the form of a bobbin. This eliminates the necessity to use glass-fiber and cotton strings as a support for Litz wire during the manufacturing process, which can catch air bubbles during casing process.

It is also good for the bobbin to have supporting protrusions with through holes on its external wall, onto which the Litz wire is wound. The bobbin used as a supporting construction can be machined to form supporting protrusions onto which the Litz wire is led. Holes are drilled in the support protrusions to facilitate epoxy flow and impregnation through the bobbin structure, which enhances production processes and provides better insulation without trapped gas bubbles. Beneficially, the bobbin can have a padding material onto which the Litz wire may be wound.

Alternatively, the bobbin used as a supporting construction can have a padding material on which the Litz wire is wound. Padding material holds Litz wire on its position on the bobbin. It also improves technological process, minimalizing the risk of cracks is casted part as the temperature changes are limited.

Alternatively, the windings are made of at least one sheet of foil made of copper or aluminum with interlayers of insulation material and, preferably, the foil can have a thickness in a range from 0.05 mm to 0.25 mm. Beneficially the foil has perforations up to 20% of its surface.

Instead of Litz wire, aluminum or copper foil can be used. Coils are wound with sheets of foil with layers of insulation material in between the foil turns, especially with interlayers of nonwoven fabric. As an insulating material, interlayers made from plastic foils can also be used, for example, mylar foils or other foils made of polyethylene terephthalate (PET). The plastic films can be self-adhesive and pre-applied to the copper or aluminum foil.

The width and thickness of the copper foil sheets is such that the cross-section area of the copper foil is equivalent to the cross-section area of the equivalent Litz wire in terms of the electrical resistance for the operating frequency. For example, if the wire were wound with 6×6 mm2 Litz wire, then the equivalent foil winding dimensions could be 250 mm width and 0.144 mm thickness. The nonwoven fabric, especially polyethylene terephthalate (PET) nonwoven fabric, is easily penetrated with the epoxy, which ensures good insulation between the winding turns, so that there is no necessity to use enameled foil—the impregnated nonwoven provides the insulation between the turns. If a larger winding cross-section is required, it is possible to fold two or more layers of enameled foil, to achieve the required winding dimensions. The foil winding wound in parallel with the nonwoven insulation results in a compact and stable winding. The process is quick and efficient and there is no need for additional stabilizing supports. The winding can be made of sheets of foils with width equal to width of the coil or sheets of coil might be composed of several interconnected sheets of foil.

Mentioned foil properties enhance production process. In particular, perforations in foils facilitate epoxy flow between foils and interlayers of insulating materials.

In one general aspect, the present disclosure is also directed to a medium frequency transformer comprising a transformer coil according to the invention. Preferably, a medium frequency transformer has the high voltage barrier (6) which is potentialized by means of a potentializing lead (X), which is connected to the high voltage barrier 6 at an arbitrary position between the edge and the middle of the high voltage winding (2).

The present disclosure is also directed to an inductive element comprising a transformer coil.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A transformer coil, comprising:
a low voltage winding;
a high voltage winding;
a supporting construction onto which the low voltage winding and the high voltage winding are wound to form the transformer coil;
wherein the transformer coil is immersed in a main insulation material;
wherein the transformer coil further includes a first barrier arranged proximate to the low voltage winding, and a second barrier arranged proximate to the high voltage winding; and
wherein the first barrier and the second barrier are gas-tight and semiconductive.

2. The transformer coil according to claim 1, wherein the first barrier and the second barrier are made of a semiconductive thermoplastic material, or epoxy resin doped with at least one of carbon black, graphite, graphene nanotubes, silver, and copper.

3. The transformer coil according to claim 1, wherein the transformer coil further includes an individual casing for each of the high and low voltage windings, and wherein the first barrier and/or the second barrier is/are incorporated into the individual casing of each of the high and low voltage windings.

4. The transformer coil according to claim 1, wherein the supporting construction is segmented into a supporting construction for the high voltage winding and a supporting construction for the low voltage winding, and wherein the supporting construction of the high voltage winding is made of a semiconductive material, and the supporting construction of the low voltage winding is made of a dielectric material.

5. The transformer coil according to claim 1, wherein at least one layer of an interlayer insulation material is interposed between layers of the high and low voltage windings, and wherein the at least one layer of the interlayer insulation material is made of polyethylene terephthalate (PET) nonwoven fabric or non-woven polypropylene (PP).

6. The transformer coil according to claim 1, wherein the high and low voltage windings are made of Litz wire.

7. The transformer coil according to claim 6, wherein the Litz wire includes insulation shielding tubing, and wherein an internal surface of the insulation shielding tubing is made of a dielectric material and an external surface of the insulation shielding tubing is made of a semiconductive material.

8. The transformer coil according to claim 6, wherein the supporting construction for the high and low voltage windings is made of Litz wire, and wherein the supporting construction is formed as at least one bobbin.

9. The transformer coil according to claim 8, wherein the at least one bobbin further includes supporting protrusions with through holes on an external wall thereof onto which the Litz wire is wound.

10. The transformer coil according to claim 8, wherein the at least one bobbin further includes a padding material on an external wall thereof onto which the Litz wire is wound.

11. The transformer coil according to claim 1, wherein the high and low voltage windings are made of at least one sheet of foil made of copper or aluminum with interlayers of insulation material.

12. The transformer coil according to claim 11, wherein the at least one sheet of foil has a thickness in a range from 0.05 mm to 0.25 mm.

13. The transformer coil according to claim 12, wherein the at least one sheet of foil further includes perforations extending up to 20% of its surface.

14. A medium frequency transformer, comprising:
a transformer coil, the transformer coil comprising:
a low voltage winding;
a high voltage winding;
a supporting construction onto which the low voltage winding and the high voltage winding are wound to form the transformer coil;
wherein the transformer coil is immersed in a main insulation material;
wherein the transformer coil further includes a first barrier arranged proximate to the low voltage winding, and a second barrier arranged proximate to the high voltage winding; and
wherein the first barrier and the second barrier are gas-tight and semiconductive.

15. The medium frequency transformer according to claim 14, wherein the second barrier is potentialized by a potentializing lead that is connected to the second barrier at an arbitrary position between an edge and a middle of the high voltage winding.
